(19) United States
(12) Patent Application Publication
(10) Pub. No.: US 2005/0081141 A1
(43) Pub. Date: Apr. 14, 2005

(54) Visual programming system and method

(75) Inventor: Gunnlaugur Jonsson, Reykjavik (IS)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Einfalt ehf., Reykjavik (IS)

(21) Appl. No.: 10/682,441

(22) Filed: Oct. 9, 2003

(51) Int. Cl. G06F 15/00

(52) U.S. Cl. 715/503

(57) ABSTRACT

The present invention provides a user-friendly visual programming and modeling environment with a spreadsheet interface. The invention allows the creation of complex software applications and programs in real-time. A user with no programming skills can easily develop object-oriented software programs. Each spreadsheet can represent an object, and the object can interact and send messages to other objects, which can also be represented by spreadsheets. In addition to variables and formulas, the cells in the spreadsheets can contain commands, definitions of methods and definitions of functions. One column of a spreadsheet may also function similar to a code text editor. In another embodiment, the code can either be complied or translated within a spreadsheet program to create software applications. The invention may include features to make programming easier by including the ability to drag and drop coded objects from a spreadsheet into a form. In this way, different types of objects may be dynamically coded and compiled at runtime. The data of these objects can be directly linked to the data of the cells.

### BACKGROUND

Electronic spreadsheets are a popular computer tool for handling data. A number of spreadsheet programs have been on the market, for example, Microsoft Excel, Corel Quattro Pro and Lotus 1-2-3. Electronic spreadsheets can store data and make calculations from the data by using functional relationships that are defined in the cells of the spreadsheets. These functional relationships are static, i.e. the functions define a constant relationship between values of different cells, where the value of one cell is defined as a function of the values of other cells.

Some electronic spreadsheet programs can link one spreadsheet to other spreadsheets that contain related information, updating the data in the linked spreadsheets automatically. Electronic spreadsheet programs may also include programming or “macro” capabilities that expand the program's functionality, for example, for creating and sorting databases. Excel, for instance, uses the programming language Visual Basic for implementing macros. Before Visual Basic, Excel used a macro language that executed code located in the cells of a spreadsheet. In general, however, these extensions to the basic spreadsheet program do not facilitate sophisticated programming. In particular, such programming tools are often incapable of creating sophisticated software applications, namely, those that can be created with object-oriented programming techniques.

Object-oriented programming is a powerful approach to creating and managing complex software programs and software components. The object-oriented paradigm offers programming features such as encapsulation, polymorphism, and inheritance, which can be used to create sophisticated software applications. A software application created with an object-oriented language may consist of a collection of discrete objects that are self-contained collections of data structures and routines that interact with other objects. Unfortunately, an object-oriented programming language can be difficult for the novice programmer to grasp. In addition, products developed using such languages often suffer from a lack of established practices required for their development.

There are graphical languages that can be used to facilitate object-oriented software engineering. Methodologies, such as Unified Modeling Language (UML), for example, provide a graphical language for visualizing, specifying, constructing, and documenting the artifacts of a software-intensive system. UML provides a standard method for writing the specifications for software architecture. This includes intangible concepts such as business processes and system functions, as well as concrete concepts such as classes written in a specific programming language, database schemas, and reusable software components. While UML may aid a software engineer or corporation in designing software, it does not provide a programming environment to develop and compile object-oriented software.

### SUMMARY

One of the biggest challenges in developing complex software systems that are tailored to a particular industry or corporation's needs, is that, in general, it requires highly trained programmers to develop the software product, which can be cost prohibitive. Moreover, because such programmers are often poorly versed in the needs and demands of a particular industry or corporation, the final software system often does not effectively satisfy the needs or demands of the corporation. As a result, a company, for example, may request a series of software system updates to incorporate certain features that were overlooked by the programmers during the development phase. Frequent updates can cost the company dearly. Ideally, the company's personnel could create their own software systems so that the company could effectively tailor their system to meet its needs. In general, however, the average company employee does not possess the programming skills to create or update such a system. Therefore, it is typically not possible for a company to have its own employees design their software systems.

The present method and apparatus provides a user-friendly programming environment that can enable the creative design of custom software products. With the invention, users can design their own custom software and even their own custom approach for making software development a rational industrial process. The present invention can expand the possibilities in spreadsheets beyond conventional macro languages. Macros, typically, are programmed in a programming language in a different environment, usually a text editor. With the present invention, however, programming can take place in the cells of the spreadsheet using so-called commands and methods. As in object-oriented programming, for example, a method (operation) can execute commands. The invention can use an operation to execute commands within the same spreadsheet.

The invention can be viewed as a spreadsheet program, which is a general programming tool with vast capabilities. The invention could also be implemented as an add-on to other spreadsheet programs, extending their capabilities. In embodiments of the invention, these capabilities are extended to create an object-oriented programming system. This system enables a user to create a software program that is a collection of discrete objects, which are self-contained collections of data structures and routines that interact with other objects. This system represents objects using spreadsheets.

The invention can provide an object-oriented software engineering modeling system. Unlike prior art modeling languages, such as UML, the invention creates both a modeling and programming environment for developing and implementing software applications. By using a spreadsheet program interface, the invention enables developers to specify, build, document and implement software systems.

In aspects of the invention, a class can be created with a spreadsheet. The class can define the data structures and routines associated with objects in the class. For example, a class can specify the instance variables, behaviors (operations), and inheritance (parents, or recursive structure and behavior) for objects. In some embodiments of the invention, objects respond to messages and these messages can be the principal means of communication. Other aspects of the invention use procedure-call mechanisms to interact with objects.

Different spreadsheets (i.e. objects) may interact by sharing their operations. This can provide an environment where spreadsheets or spreadsheet workbooks (a workbook may be a number of spreadsheets bundled together) interact and thus communicate as objects in an object-oriented system. Commands and operations can be included in the same sheet.

Some embodiments of the invention function in many ways as a visual object-oriented programming language like Visual C++ or Delphi. In such languages, objects interact using so-called methods or operations. Another embodiment of the invention includes a child sheet or workbook, which inherits a copy of instructions or characteristics of its parent sheet or workbook.

The present invention can define loops within a spreadsheet. Loops are an iterative process which repeat the same action over and over until a condition no longer applies, or begins to apply. Loops may be implemented with so-called “loop sheets.” Loop sheets can be individual sheets or parts of larger sheets. A user can define the conditions for a loop in cells on a loop sheet. Cells on the loop sheet may include a temporary value that is moved to other designated cells on the loop sheet in each round of the loop. The new data in those cells can then influence the values of the former cells in the next round. This can be repeated until the condition for the loop to run no longer applies.

Changes to values in one cell can produce changes in other cells. For example, if a cell includes a value that is referenced by other cells in their functions, operations, or commands, any changes to the value in declared in a cell causes the value referenced in other cells to be recalculated at runtime. If a cell includes a value that is referenced by other cells in their formulas, for example, any changes to the value are automatically communicated to the other cells at development time.

In another embodiment of the invention, a so-called “code column” can be defined within a spreadsheet. The user can define one or more columns of a spreadsheet as a code column. A code column behaves in many ways more like a text editor rather than a spreadsheet. Every cell of the code column may be similar to a line in a text editor. For example, when the user selects enter, e.g., with a cell in a code column selected, a new cell can be inserted and can be moved down. References to the cells that move can be automatically corrected and updated. A code column can have its own scroll bars.

In another aspect of the invention, it can be possible to use a mouse (or appropriate input device) to drag a copy of the contents (instructions, attributes or data objects) associated with one or more cells of a spreadsheet onto a working window. The dragged contents become the properties of the working window. This enables a developer to manipulate the user interface and behavior of the window by specifying the desired content of the window in the cells of the spreadsheet. For example, the content can include any algorithms, menu options, attributes, e.g., an input field, check box, radio button, menu object, popup menu object, label (i.e. a non-editable text), button, combo box or list box. The user can determine the type of the attribute even before dragging the cell contents to the window, by assigning the attribute type to the cell. Once the cell contents are dragged and dropped onto the working window, the invention assembles any attributes and algorithms associated with the instructions in the cell to construct the appearance and behavior of the window. As a result, the look and, feel and behavior of the object on the working window is connected to the cell. In this way, any data or instructions associated with the cell is coupled to a window.

In addition, this coupling of the cell to the window can be responsive to certain user interaction, such as a drag and drop event. That is, the event of dragging and dropping the cell contents, such as an object, onto the working window. In particular, when the event of dropping the cell object onto the window occurs, the invention processes the properties of the window based on the object and generates them at runtime. The developer can immediately view and interact with the object on the window.

The invention can also use the spreadsheets to customize their respective objects event processing techniques. Typically, an event is an action or occurrence, generated by a user or by the system itself, to which a computer program might wish to respond. For example, key presses, button clicks, mouse movements and timers are all types of events. The invention can be used to create objects with event processing capabilities, and these objects can be used to create event-driven programs. In addition, the invention can create polling-driven objects that interrogate, and effectively anticipate, interactions with the program. The event processing can be implemented through the creation and maintenance of event types, handlers and queues in the cells of the spreadsheet.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a screenshot illustrating a spreadsheet window according to an embodiment of the present invention.

FIG. 2 is a diagram illustrating the definition of an operation in object A and a command to execute this operation in object B.

FIG. 3 is a flow diagram describing the execution of an operation in object A from a command in object B.

FIG. 4 is a screenshot illustrating a definition of an operation according to an aspect of the invention.

FIG. 5 is a screenshot illustrating a definition of a function according to an aspect of the invention.

FIG. 6 is a diagram illustrating inheritance of operations between a parent object and its child objects.

FIG. 7 is a screenshot illustrating a loop sheet according to an aspect of the invention.

FIG. 8 is a diagram illustrating what happens when a loop is being executed according to an aspect of the invention.

FIG. 9 is a screenshot illustrating a loop sheet according to an embodiment of FIG. 7.

FIG. 10 is a screenshot illustrating a loop according to an embodiment of FIG. 7.

FIG. 11 is a screenshot illustrating a code column according to an aspect of the invention.

FIGS. 12a-12b are diagrams illustrating dragging cells onto a form or working window according to an aspect of the invention.

FIG. 13 is a diagram illustrating an overview screen view according to an aspect of the invention.

FIG. 14 is a schematic overview of a computer system for implementing the present invention.

FIG. 15 is a block diagram illustrating the object-oriented programming concept of inherency in a spreadsheet environment according to an embodiment of the invention.

FIGS. 16-17 are block diagrams illustrating the spreadsheet object-oriented programming system according to an embodiment of the invention.

### DETAILED DESCRIPTION OF THE INVENTION

A description of preferred embodiments of the invention follows.

The development of customized software systems can result in a long, involved and expensive process, which is compounded by the unique challenges companies face to survive in this dynamic global environment. In today's dynamic global environment, the critical nature of accuracy and speed can mean the difference between success and failure for a new product or even a company.

The present invention creates a user-friendly spreadsheet environment that can enable any company, user or automated system to develop and implement comprehensive custom-built software systems that can satisfy their needs. The invention simplifies the process of constructing, maintaining and modifying software systems and programs. For the average computer user, object-oriented programming can be difficult. It is likely, however, that the average computer user would find a typical spreadsheet program relatively easy to use. In fact, most computer users today have some working knowledge of the spreadsheet environment. The present invention uses the common features of a spreadsheet program that are known to the average computer user, such as the generic look, feel and functionality of a spreadsheet. The invention creates an object-oriented programming environment using these common spreadsheet features. In this way, the invention is a powerful programming tool for novices and professionals because it is both simple to use and comprehensive. Anyone with working knowledge of a spreadsheet environment can create software using object-oriented programming techniques with the invention.

The invention can be used to build nearly any type of object-oriented software system. With the invention, creating a customized software system that dovetails with a company's needs can be fast and simple. Companies can make their own systems, even as easily as one can construct calculations in an electronic spreadsheet. This is, for instance, a great benefit for small companies that cannot afford expensive customized software.

With the invention, there will be less need for specialized programmers. The present system creates a user friendly programming environment, and individual workers, with little knowledge of programming, e.g. financial experts that work at banks and have little or no programming experience, will be able to make their own programs using basic spreadsheet skills and knowledge of the present system. For example, systems that can be implemented with the present system include: derivative valuation systems, sales systems for financial products, valuation systems for stocks, risk management systems, systems for monitoring profit and loss of financial contracts, portfolio management systems etc. The use of the present system, however, is not limited to these examples. Rather, the present system can be used to implement various software systems or components of other software systems. It could, for instance, be used to build general sales systems, customer relations systems, accounting systems, systems for scientific research, computer games, and the like.

I. Contents of Cells.

One aspect of the invention provides an object-oriented programming environment that uses electronic spreadsheets. Individual spreadsheets or groups of spreadsheets are objects that communicate and send messages to execute operations. An operation in the context of the invention is usually called a method, in programming.

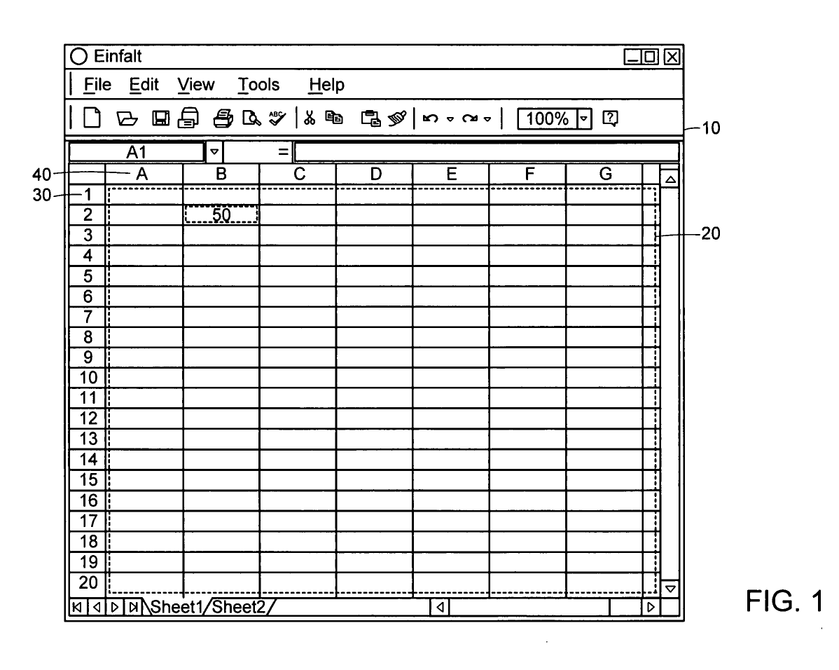

FIG. 1 shows a blank spreadsheet. The spreadsheet window 10 is for illustrative purposes only, and the actual look and feel of the window 10 may take many forms. The spreadsheet 10 includes a cell matrix 20. The cell matrix 20 includes rows that are labeled with numbers 30 and columns that are labeled with letters 40. Individual cells have an address that consists of the name of the column and the name of the row. The cell 50, for example, has the address B2.

One aspect of the invention that is not generally possible in other programming environments, is that the outcome of calculations can be viewed while programming. It is also possible to organize the calculations better and even do partial calculations that produce results that may be used in future calculations. All this decreases the risk of error and makes programming easier. The advantage of the invention over traditional spreadsheet programs, however, is that the invention provides a greater ability, due to the extensions that have been made. There is more functionality than traditional spreadsheet programs. A further important aspect of the invention compared to spreadsheet programs that are enabled with a macro programming language is that the programming with the invention can be done within the spreadsheet itself, not in a different environment, such as a text editor.

Cells in spreadsheets can contain a few different kinds of items that are entered using the keyboard. The following can be entered:

A. Variables.

A cell can be used as a variable that is either text or a number or any other data type, including arrays. The variable can be referred to in formulas by using its locations in spreadsheets, for example A1 (column A, line 1) (40, 30). It is also possible to designate names for individual cells and use those names in formulas. This is similar to traditional spreadsheet programs. According to one embodiment of the invention, only cells in the same object (i.e. spreadsheet workbook, or a group of sheets) can be referred to. Different sheets and objects can communicate by using operations.

B. Text and Numbers That are not Used as Variables.

In addition to using a cell as a text or number variable, a programmer could also enter text in a cell to explain the program to future users. For example, text may be entered, which serves as a type of a headline, to show what kind of calculations take place in nearby cells. This is often done in traditional spreadsheet programs.

C. Formulas.

A formula can be entered into a cell the same way as in traditional spreadsheet programs. The cell becomes a variable that calculates its value from the value of other variables. If the value of a referencing cell is changed, no command has to be made for this cell to update its value, rather, the update occurs automatically. These formulas look the same way as in traditional spreadsheet programs. Example:
=sum(A1:A3)

This formula adds up the numbers in cells A1, A2 and A3. Such a formula, which is common for conventional spreadsheets, can now be used in an object-oriented programming environment with the present invention.

D. Commands.

A command can be entered into a cell of a spreadsheet. In general, this is not possible in traditional spreadsheet programs. In one embodiment of the invention, a command begins with a slash: /. A command can execute various procedures, for example, operations. Commands can contain conditions (using “if” statements). A command can, for instance, change the value of a variable. Example:
/A1=5

This command enters the number 5 in cell A1. Another example of a command: /Print(report1)

Commands can refer to operations that have been defined. Operations are discussed in more detail below. Also, there can be many kinds of predefined commands that make it a complete programming environment. For example, commands can control a printer in detail, a screen, a hard disk, etc.

E. Definitions of Operations.

Calling operations, i.e. using commands to send messages, is a way for different objects to communicate. According to an embodiment of the invention, it is the only way for different objects to communicate. As such, the objects cannot access the variables of each other, or communicate in any way, without calling operations.

An operation receives input and then executes commands and returns output. A definition of an operation begins with an asterisk: *, according to an embodiment of the invention.

Generally, a definition of an operation may appear as follows:
*Commands: NameOfOperation(Input)=Output

A command to execute an operation in another sheet may appear as follows:
/Output=NameOfObject.NameOfOperation(Input)

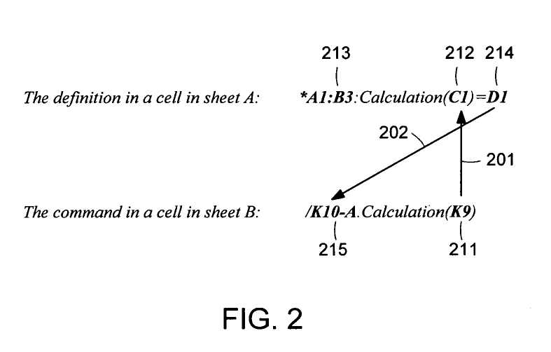

FIG. 2 is a diagram of an example showing the definition of the operation Calculation in sheet A and a command to execute this operation in sheet B. The following example demonstrates the execution of a command. At all times, all formulas are recalculated and brought up to date when needed:
1) Step one: The input goes from sheet B to sheet A. The number in cell K9 (211) in sheet B is put into cell C1 (212) in sheet A. The flow of data is shown in the picture with an arrow 201.
2) Step two: The commands in sheet A are executed. These commands are in cells A1:B3 (213), i.e. A1, B1, A2, B2, A3 and B3. The commands are executed in this order. Generally, commands in cells are executed in the same order as one reads, from left to right, one line at a time.
3) Step three: The output goes from sheet A to sheet B. The number in cell D1 (214) in sheet A is put into cell K10 (215) in sheet B. The movement of data is shown in the picture with an arrow 202.

Input values and changes that are made to an object (sheet A in the example above) during the execution of an operation can be undone at the end of the execution according to an embodiment of the invention. In this way, the values can be dynamic. Such operations, however, which do not change the data of the object that they are in, can be, for example, distinguished by using two asterisks at the beginning of the definition (**) instead of one. The definition could look like this:
**Commands: NameOfOperation(Input)=Output

### EXAMPLE

**A1:B2: Calculation(C1)=D1

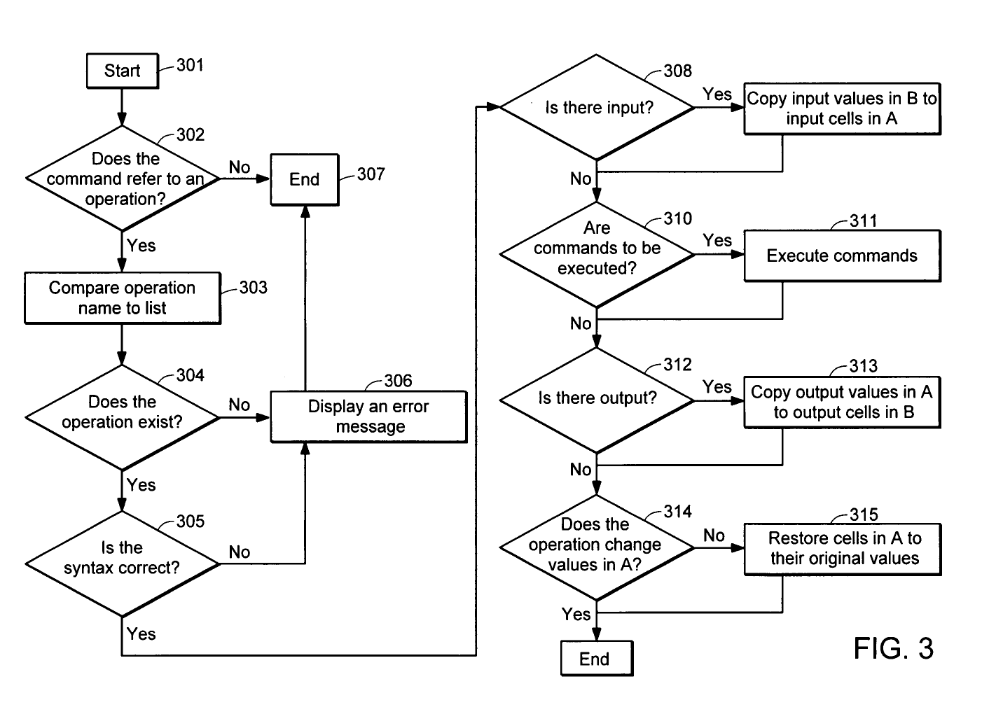

A flow diagram of the steps for running a command is shown in FIG. 3. This happens at runtime. The command that is being executed is in object B and the operation that it refers to is in object A._If the command refers to an operation as asked in 302, the operation is found on a list 303, if it exists 304. Then, the syntax is checked 305 and the operation takes place 308-315. The sequence of events does not have to be exactly like that described in FIG. 3. For example, there may be error checking 306, 307 at different levels.

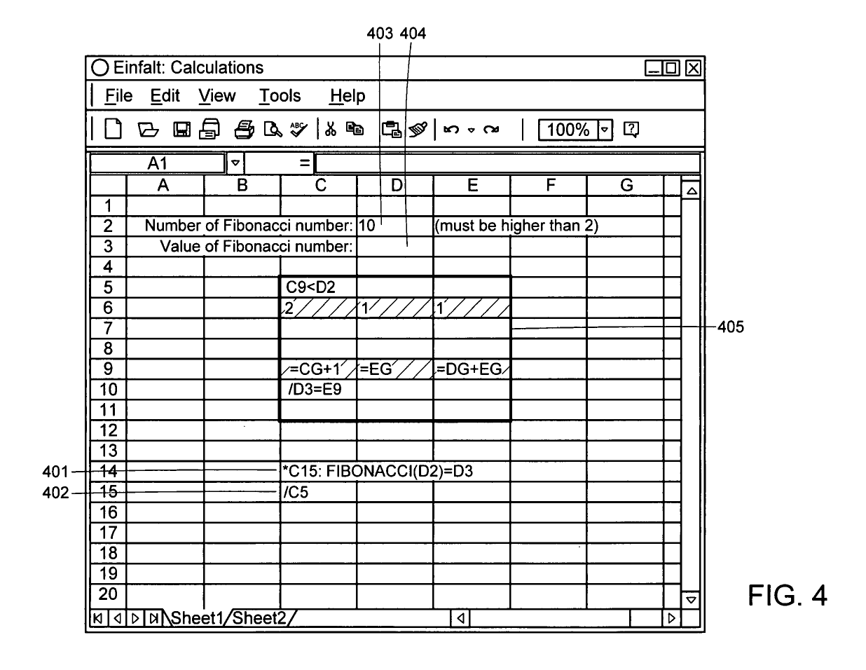

FIG. 4 shows the definition 401 of an operation. There is an input cell 403 and an output cell 404. The operation executes one command 402 that actually executes a loop 405. A loop is described in more detail below. Operations that do not execute any commands are also possible. According to an embodiment of the invention one does this by omitting the command part of the definition:
*NameOfOperation (Input)=Output

### EXAMPLE

*Calculation(C)=D1

It is also possible to define operations that do not receive input or return output. According to an embodiment of the invention, one does so by omitting the relevant part of the definition. This is the form of a definition, where there is no input:
*Commands: NameOfOperation( )=Output

### EXAMPLE

*A1:B3: Calculationo=D1

This is the form of a definition, where there is no output:
*Commands: NameOfOperation(Input)

### EXAMPLE

*A1:B3: Calculation(C1)

This is the form of a definition, where there is no input and no output:
*Commands: NameOfOperation( )
*A1:B3: Calculation( )
   F. Definitions of Functions.

According to an aspect of the invention, functions can be defined in the cells of the spreadsheet. Functions, for example, are one way to reuse calculations. Functions can be used in formulas that begin with the character “=”. As a simple example: If a function, like a polynomial of a number in cell D2, has been calculated in cell D4 the function Polynomial can be defined. Although the definition of a function may appear similar to the definition of an operation, functions are used in formulas and not in commands. In general, a function can be defined as follows:
*Function. NameOfFunction(Input)=Output

### EXAMPLE

*Function: Polynomial(D2)=D4

A function can be used in a formula this way:

=NameOfFrunction(Input)

### EXAMPLE

=Polynomial(E15)

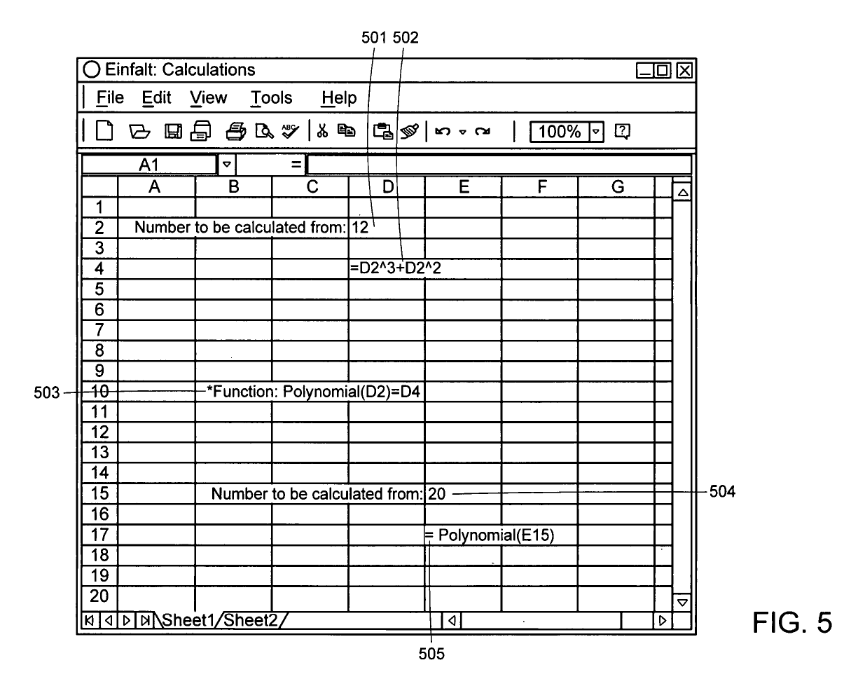

The number in cell E15 is used to calculate a new value that is shown in the cell that contains the formula, E17. This can be seen on FIG. 5. In cell D2 (501), there is a number that is used in a polynomial cell D4 (502). The definition in cell B10 (503) defines a function so that the polynomial can be reused. The polynomial is then reused by a formula in cell E17 (505) to calculate a value from the value in cell E15 (504).

II. An Object-Oriented Programming Environment.

A. Compilation or Interpretation.

Before going further, it should be noted that programs in the present system could either be compiled or interpreted. Compilation means that a program that has been constructed with the present system is compiled, so that it can be run, independently of the present system's environment. Compilation produces an executable file. Interpretation, on the other hand, means that code is not compiled, but interpreted at runtime within the present environment. In other words, while using spreadsheets, one can use operations and other features of the invention. Therefore, when the invention is in interpretation mode, compilation of the program being created is not necessary. The program can run without ever being compiled in the traditional sense. As a result, the program can be dynamically updated while it is running and while it is being developed.

The compilation version of the invention produces programs, where the user does not necessarily see any spreadsheets. The product can be any kind of stand-alone programs. This version of invention can be compared to programming environments such as Visual C++ and Delphi.

The interpretation version of the invention is used within a spreadsheet program. It is a kind of a macro language that constructs procedures that are used when using spreadsheets. This version of the present system can be compared to macro languages, such as Visual Basic.

B. Communication Between Objects.

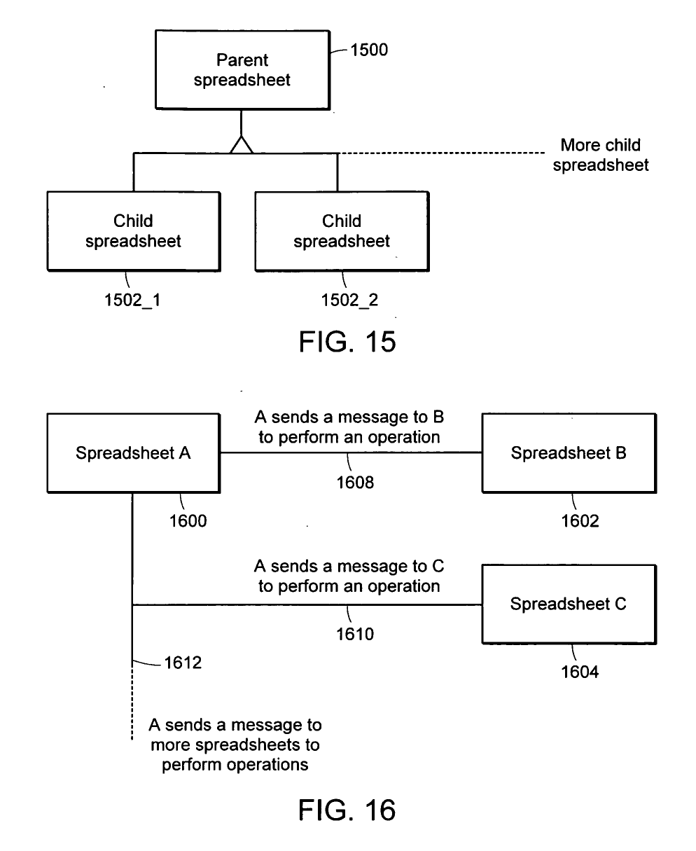

Objects consist of one or more individual sheets (matrices of cells). Objects communicate using operations 1608, 1610, 1612 as shown in FIG. 16. It should be noted that operations referred to herein are methods in object-oriented programming. Operations have already been discussed in section I. E. supra. According to an embodiment of the invention, only operations can be used for communication between objects. According to another embodiment, operations are not required and objects can communicate by calling procedures referenced in other cells, e.g. refer to cells in other objects, using formulas. According to yet another embodiment, the programmer has the ability to choose which cells in an object are open and visible to other objects in a program.

A command is used to send a message, from one object to another, to perform an operation. A command that refers to a message can be checked for errors at different stages, when the command is entered into a cell (at development time), when the program is compiled, i.e. in the compilation version of system (at compilation time) and when the command is run (at runtime). Any code in the system can actually be checked for errors at each of these three stages. Error checking at runtime does not necessarily have to take place in all cases, if a program has been compiled.

When an operation has been defined (at development time), it is put in a library of operations, so it can be referred to a later point. The library can be stored in a data cluster or database system. The library may be implemented in different ways, it can e.g. be a linked list, a hash table or a tree. The library contains information regarding, which object an operation belongs. The system can detect if a command refers to an operation that does not exist or if the syntax is incorrect at different times, as mentioned previously.

C. Classes and Objects.

In object-oriented programming, classes are constructed as models for objects.

Instances are then created based on individual classes, i.e. the models. A class is a description of a set of entities that share the same attributes, operations (i.e. methods), and relationships. To create a class, a class definition has to be created. Each class definition typically comprises a data definition and a method definition. Data definitions define the information controlled by the object, and operation definitions define the method or methods of such objects.

Typically, objects and classes are created through writing source code. Source code is a human-readable program containing statements written in a high-level language that is not directly readable by a computer. In general, source code cannot be used by a computer unless it has been compiled successfully. Object code is the machine code or instructions generated by a compiler or an assember, that was translated from the source code of a program. The machine code generated is directly executed by the system's (or computer's) central processing unit.

The classes and objects defined in such prior art source code often may not be used until the source code is compiled successfully to create new objects and classes, such as objects in a Dynamic Link Library (DLL). This means that the programmers writing the source code not only must know the programming syntax of the language (e.g., must know what “class,” “++”, “return,” or “public” in C++ means), but also need to know how to use such languages to define objects and classes. Object-oriented programming requires a substantial amount of learning and expertise. Often, there is a high learning curve involved in learning the complexities of such high-level languages, namely, the complexities in defining objects and classes.

Embodiments of the invention, however, enable the creation of classes and objects without the high learning curve required to learn the complexities of high-level languages. Further, the invention can enable the creation and use of classes and objects immediately after their definition. This leads to faster deployment of the classes and objects thereby minimizing development time of a software application.

According to an embodiment of the present invention, a class is defined by creating a spreadsheet. Such classes can then be used to create instances, using a command that can e.g. be of the form:
/new NameOfClass NameOfInstance

### EXAMPLE

/new A B

This command creates a new object B, based on the class A. The syntax does not need to be of the form depicted here.

According to another embodiment of the invention, each class is its own first instance. As a result, the concept of a class is actually not necessary and it may make the programming easier to understand to those who are not familiar with classes. New instances of an object are simply created by copying it. The syntax can be the same as described above, where a new object B, is created as a copy of the object A:
/new NameOfInstance1 NameOfInstance2

### EXAMPLE

/new A B

In other words, for every class, there is a first instance that has the same name. Therefore, classes may still be used, although not visible to the user of the present system, in this embodiment.

In the interpretation version of the invention, where code is not compiled, but interpreted at runtime within the present environment, it may be particularly useful to use a class as the first instance of an object, for it is used within a spreadsheet program, and the objects will actually be visible on the screen of the user. It may therefore be more complicated for the user to view classes and instances separately, and have two copies of substantially the same information on the screen. For example, a typical spreadsheet user is trained to enter data and formulas onto the same sheet that they are using, and not viewing them as classes that have to be used to make instances. It may be simpler for a user of the invention to create an instance directly, that is going to be used, rather than creating a class, i.e. a model for the instance, that has to be used to create the instance afterwards.

According to an aspect of the invention, there can be a main object that exists at the initialization of a program. This object can then be used to control the existence of other objects. This object will serve as a main program that will use other objects.

According to an embodiment of the invention, the existence of objects at initialization can be set without using a main object. This can be done by labeling objects as existing, e.g. by using the mouse or other appropriate input device.

In an embodiment of the invention, where classes are also their first instances, there is no need to control their existence at the initialization of a program because they always exist at the time of creation.

According to another embodiment of invention, so-called events are used to control what happens in a program made with the system software. Commands can be connected with certain events, so that they will be run if those events take place. An example of an event is the creation of an object.

According to an embodiment of invention, it is possible to use objects that are not merely sheets or groups of sheets. These objects do, however, have sheets as part of them. For instance, one such object is a form or window, which can be customized by the programmer, adding buttons, editable text fields, radio buttons etc. A sheet (or sheets) is coupled with this object, and that sheet would contain code that would belong to this object. Together, the sheet and the form can be viewed as one object. In connection to objects like forms, events exist. The event can include an event type, event handler, and event target. The event type can e.g. be the click of a button or the editing of a field. Commands in a sheet can be connected to these events, so that when the events take place, the corresponding command is executed. The connection of a command to an event can be made by entering a command or a cell name next to the name of the event on a graphical event list that can be generated for every object. Also, objects can have properties that can be referred to and changed in code. One such property could be the color of a button. These properties can be set in a very similar way as in other programming systems, for example:
/button1.color=green

According to an embodiment of invention, so-called metaclasses are allowed, i.e. a class can be an object. Then it is, for example, possible to call operations that correspond to the class itself, but not individual instances of the class. This is useful, for example, when one requires information about how many instances of a class have been generated.

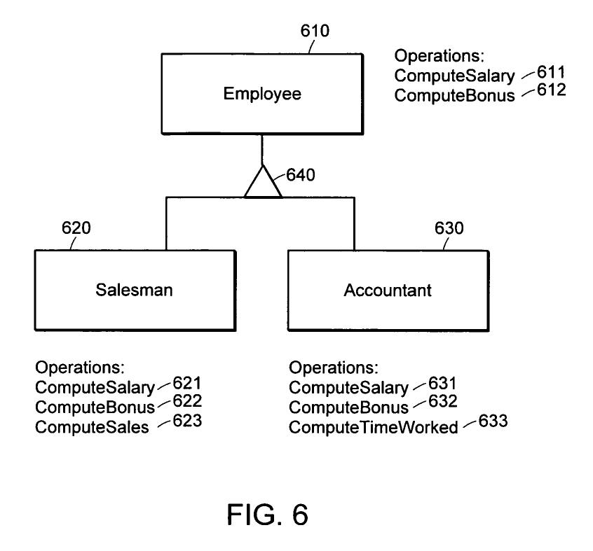

According to an embodiment of invention, inheritance is enabled. Inheritance is used to reuse what has been done before, in order to ensure consistency. As shown in FIG. 6, one object could be, for example, for an employee 610 and therefore would have certain variables like salary 611 and bonus 612. Then one could make the object salesman 620 that would inherit those variables but add some other variables and events that apply for a salesman 620, such as how much the salesman 620 has sold 623.

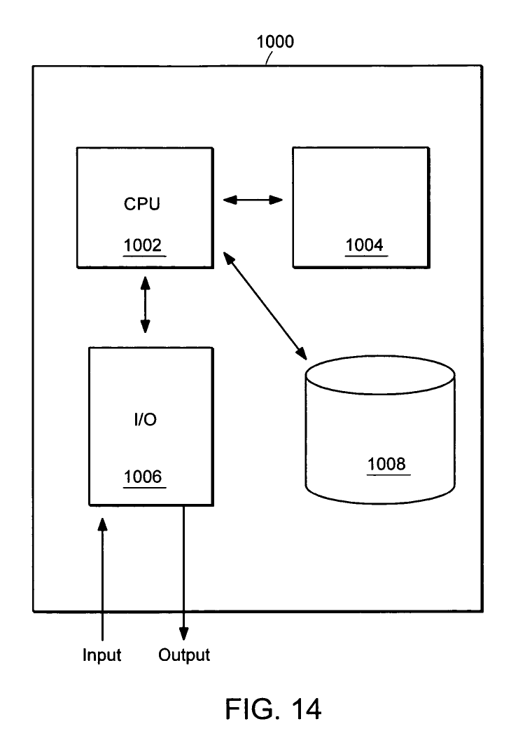

As shown in FIG. 15, any child spreadsheets 1502-1, 1502-2 inherit from their parent spreadsheet 1500. A child 1502-1, 1502-2 inherits the variables and operations of the parent 1500. It is possible to make new operations by the same name in the child 1502-1, 1502-2, that is, to redefine the operations. If something is changed in the parent object 1500, it changes also in the child 1502-1, 1502-2.

Referring back to FIG. 6, three classes are shown, a parent class, Employee 610, and two child classes, Salesman 620 and Accountant 630. Also shown are operations 611, 612 of the parent class 611 and 612, which are inherited by the child classes as operations 621, 622, 631, 632. These operations may be redefined in the child classes, e.g. the bonus of a salesman 622, 632 may be computed differently by the operation ComputeBonus 622 than the bonus of a normal employee. Also, there may be new operations 623, 633 in the child classes 620, 630 that are not in the parent 610, e.g., the operation ComputeSales 623 that belongs to the child Salesman class 620. The triangle 640 is a traditional way to show inheritance in object-oriented programming.

Multiple inheritance may be allowed. Multiple inheritance occurs when a class inherits from more than one parent.

In this embodiment, inheritance may be implemented by creating: A copy of the parent spreadsheet or sheets and thus implementing the child object. The copies can be viewed by clicking a tab. A copy may determined by the user with some interface indication means, such as by using dark grey letters instead of black letters to indicate that it is inherited. The copy of the parent sheet is a part of the child. One possibility, is that the copy cannot be changed in any other way but by changing the value of variables. Those changes would then only apply to the child. Commands and operations cannot be changed although operations can be redefined.

For example:

1. A child object inherits a copy of the parent sheet that can be selected by touching a tab when viewing the child sheet. When a change is made to the parent sheet that change also takes place in the copy in the child sheet.

2. All the operations of the parent sheet become operations of the child sheet. All the variables (cells) of the parent sheet become variables in the child sheet.

3. The values of the variables in the copy of the parent sheet can be changed. They are, however, the only thing that can be changed in the copy. Commands, definitions of operations, formulas and definitions of functions cannot be changed.

4. Even though operations cannot be changed in the copy of the parent sheet, it is possible to redefine them in the child sheet, using the name of the operation in a new definition.

III. Loop Sheets

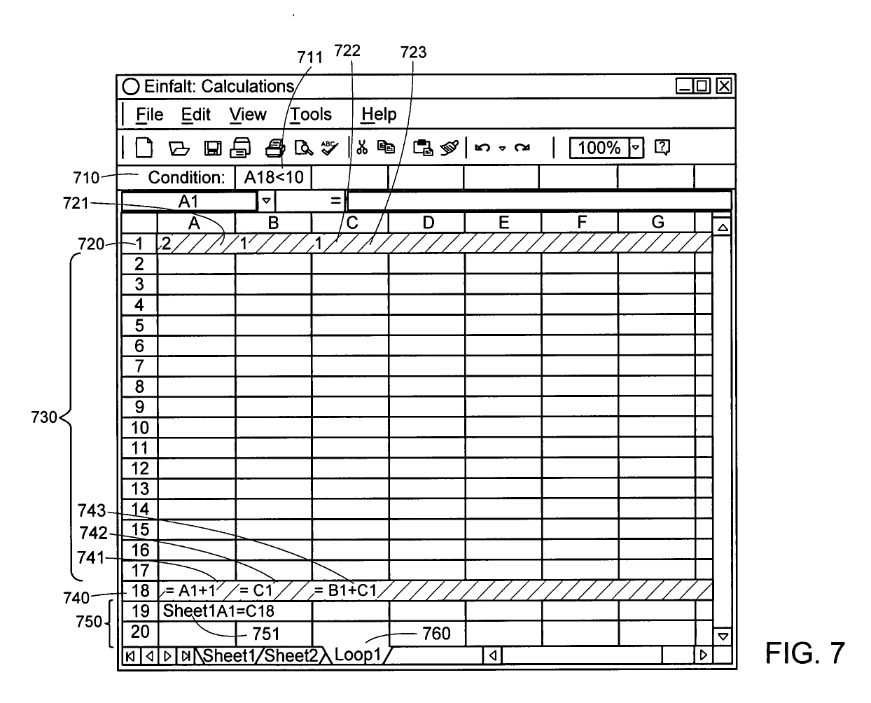

FIG. 7 is a screenshot of a Loop sheet according to an aspect of the invention. Loop sheets execute loops in a simple way. A line for conditions 710 for the execution of the loop is at the top of the loop sheet. These cells are called condition cells 711. There is an initial value line 720 that keeps values that will be used in the first round of the loop. The variables that will change in the rounds of the loop are set in those cells 721, 722, 723 in the beginning. In the white cells in the middle of the sheet 730 it is possible to do various calculations and execute commands.

In the final value line 740 values are calculated from the initial value line 720 and white cells 730 above. The values of the final value line 740 are moved up to the initial value line 720 if the conditions still apply (in spite of the formulas or values that exist there, they only define the values before the first round) and the calculations are done again. The values of cells 741, 742 and 743 are thus moved to cells 721, 722 and 723 respectively.

At the end of the execution of the loop (when the conditions no longer apply) calculations and commands in the lower white cells 750 below the final value line 740, are executed. There is one command in this example, in cell 751. Commands in those cells 750 can be used to return values to cells outside the loop. When the loop has ended, all cells within the loop are reset to their original values.

As in FIG. 7, the loop sheet can be edited by the user by choosing the tab “Loop1” 760 at the bottom. There are no calculations in the middle white cells 730 in the picture because this is a very simple loop. The loop calculates the tenth Fibonacci number and puts it in the cell A1 in a sheet that has the name Sheet1.

A loop is executed with a command. The command then only has to contain the name of the leftmost cell in the top row of the loop or the name of the loop. Example:
/G10
   Or:
/Loop1

A loop sheet can either be separate from other sheets or it can be a part of another sheet and occupy cells of that sheet. If a loop sheet is a part of another sheet there can be a frame surrounding it, to make its boundaries more obvious.

A loop sheet consists of:

A. A conditions line 710 with the conditions for a round of the loop to take place.

B. An initial value line 720 with values that are used in the first round but they can be changed before the next round. These values can for example be determined by formulas that refer to cells outside the loop.

C. An area 730 where commands and calculations can be done in each round.

D. A final value line 740 with some final values of each round that will be used in the initial value line 720 as initial values in the next round if the conditions in the top line 710 still hold. The value of a cell of the final value line 740 will be moved to a cell in the same column in the initial value line 720.

E. An area 750 where commands and calculations can be done after the last round.

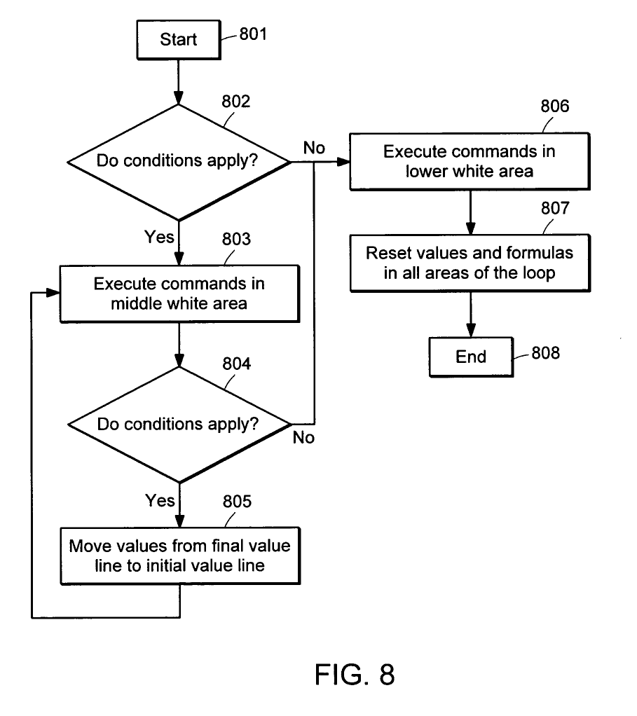

A loop is executed in the following way. At all times, all formulas in the cells of the loop are up to date. A description of how a loop is processed is shown in FIG. 8.

Step 1 (802 and 804). The condition in the top line 710 is evaluated. If the condition is true then the process proceeds to step 2. If it is false then the process proceeds to step 5.

Step 2 (805). If this is not the first round of the loop, values of the final value line 740 are moved to the initial value line 720.

Step 3 (803). Calculations and commands in the middle white area 730 take place. All formulas are updated instantly at any point, regardless of their position. The commands are executed in the same order as one reads, from left to right, one line at a time. The order of the cells to be executed may however be different and may be defined by the user.

Step 4. The process returns to step 1 again.

Step 5 (806 and 807). Commands in the lower white area 750 of the loop are executed. Then all cells of the loop are reset to their original values or formulas.

Step 6 (808). End of loop.

A loop can be executed by a command that contains its name (example: /Loop1) or a command that contains its location in a sheet (example: /G10).

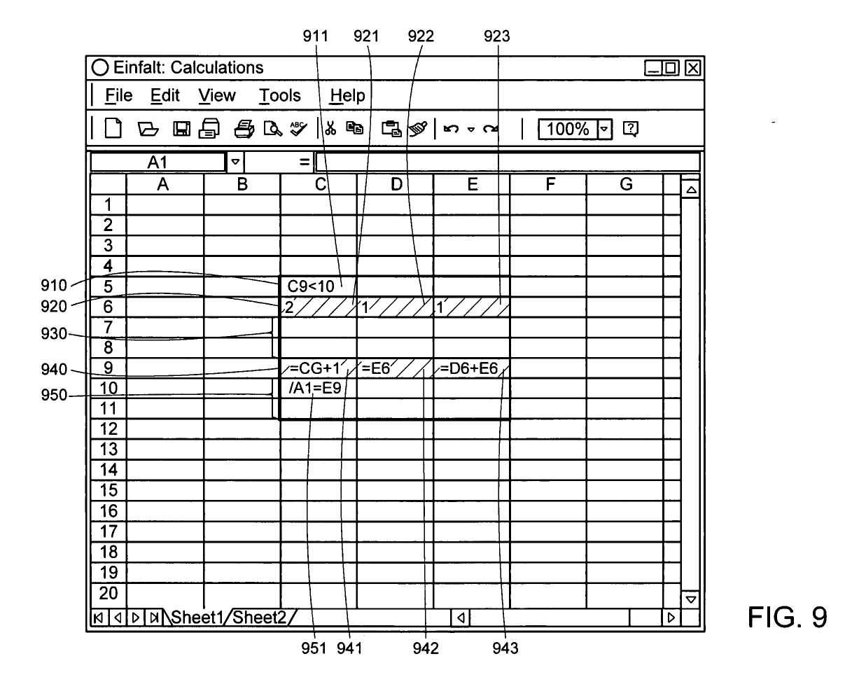

FIG. 9 is a screenshot of a loop sheet according to an embodiment of FIG. 7. This loop sheet is surrounded by a thin, grey frame within a spreadsheet (Sheet 1). This is the same loop functionally as the one pictured in FIG. 7 except for being embedded in Sheet 1. Condition cell 911 is shown on condition line 910. Initial value cells 921, 922, 923 are shown on initial value line 920. The final value line 940 holds the final values in cells 941, 942, 943 and these values are then moved into their respective initial value cells 921, 922, 923 of the initial value line 920. This process is repeated for either a fixed number of times or until the condition cell 911 holds true or false.

The tenth Fibonacci number is returned to cell A1 of Sheet 1 (the embedded spreadsheet). Sheets that are within other sheets are called sub sheets. A sub sheet of this kind, a loop sheet, can be inserted anywhere in a sheet, by the user, e.g. by using the mouse.

A loop may also be in any cell on the form of a command:
/loop(conditions, initial values, commands of each round, final values, commands at the end of the loop)

This kind of a command designates other cells as parts of a loop and then runs the loop. Example:
/loop(A1:D1, A2:D2, A3:D4, A5:D5, A6:D6)

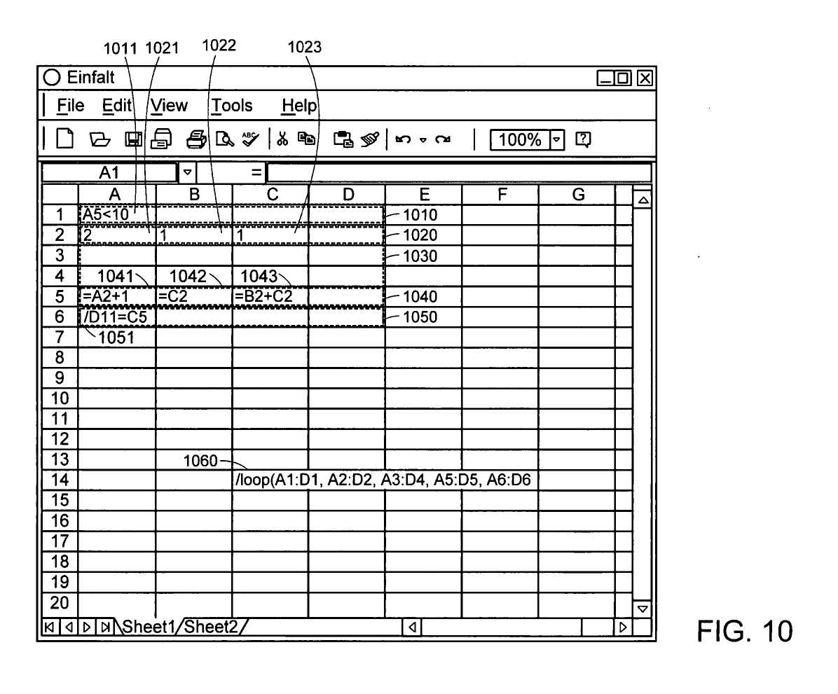

This can be seen in FIG. 10. The illustrated loop has its conditions 1011 in cells A1 to D1 (A1, B1, C1 and D1). These condition cells are marked with a dotted line and labeled 1010. The initial value line consists of cells A2 to D2, illustrated by a dotted line box (A2, B2, C2 and D2) 1020. What has been called the middle white area 1030 is in cells A3 to D4 (A3, B3, C3, D3, A4, B4, C4 and D4). The final value line 1046 consists of cells A5 to D5 (A5, B5, C5 and D5). Then, the commands 1051 that are run when the conditions 1011 no longer apply at the end of the loop are in cells A6 to D6, i.e., dotted line box (A6, B6, C6 and D6) 1050. The command for the loop to run 1060 that also defines the loop is in cell C14.

IV. Various Features.

A. Code Column.

In an embodiment of the invention, it is possible to define a so-called “code column” within a spreadsheet. One or more columns of a spreadsheet can be defined or designated as code columns by the user. A code column may have its own scroll bars, so that viewing data in the code column can be independent to viewing the rest of the spreadsheet. A code column behaves in many ways like a text editor, rather than a spreadsheet. Every cell of the code column is like a line of text in a text editor. When the user inputs a carriage return (e.g. presses “enter” or “return” on the keyboard) with a cell in a code column selected, the invention responds by inserting a new cell (e.g. newline) and moves all cells below, down. References to the cells that move will be automatically corrected. The code column is really just a normal column in a spreadsheet, with the exception that its data is edited in a different way (e.g. functioning similar to a text editor).

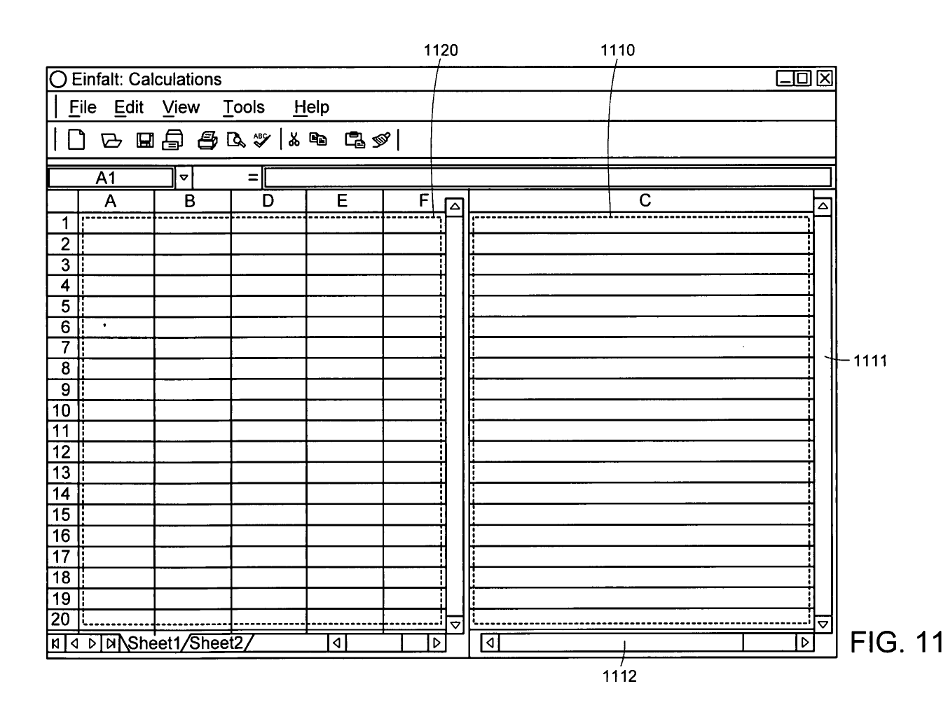

An example of a code column 1110, the column C in this case, is shown in FIG. 11. The code column 1110 has its own scroll bars 1111 and 1112 (vertical and horizontal, respectively). Scrolling in the rest of the spreadsheet 1120 can be done independently with the view of the code column unchanged. Moving up and down in the code column 1110 can also be done without changing the view of the remainder of the spreadsheet 1120.

B. Dragging Cells to Forms

In an embodiment of the invention, it is possible to use the mouse to drag a copy of a cell of a spreadsheet on to a form (or working window, such as a dialogue box, other boxes, etc.) in a visual programming environment. This will automatically create a data object (e.g. attribute or element) on the form/window, e.g. an input field, check box, radio button, menu object, popup menu object, label (i.e. a non-editable text), button, combo box or list box. The type of the object on the form or window can be determined by the user, even before dragging the cell to the form/window, by assigning the type to the cell. The appearance and behavior (properties) of the form/window will be automatically connected to the content in the cell. If the properties of the window changed, the content in the cell changes accordingly. The content in the cells can include any commands, operations and formulas associated with the cell, which can be used to implement algorithms that are used in response to events or certain conditions. A host of predefined algorithms can be provided and selected by a user. The predefined algorithms can be tailored toward a particular industry. For financial industries, for instance, predefined algorithms can be included that are often used in financial applications and simulations. This can include option valuation, numerical analysis and stochastic modeling techniques (erg. Black-Scholes models, Binomial Valuation Models, Monte Carlo Simulation Model and binary tree methods). In addition, the user can define new types of algorithms or data processing techniques with the invention.

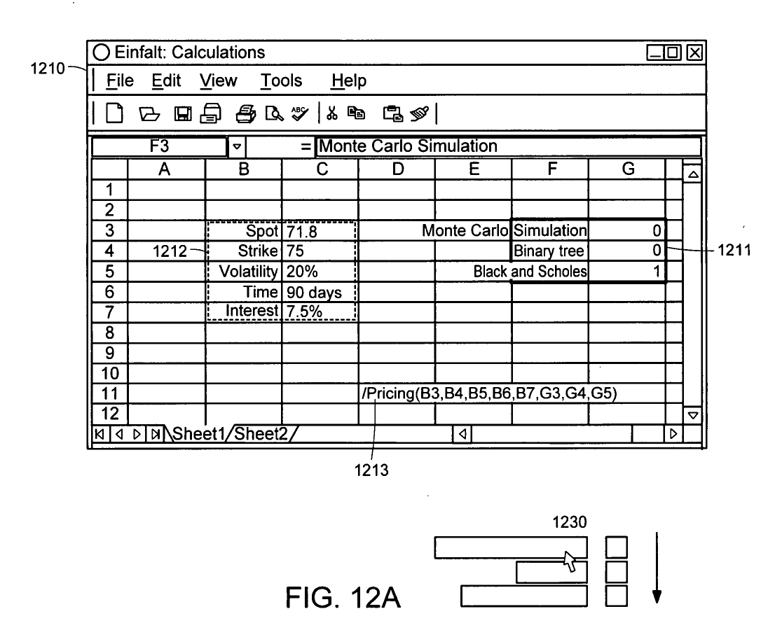

FIGS. 12a-12b show a case where cells 1211, 1212, 1213 are being dragged from a spreadsheet 1210 to a form or working window 1220 and what the form/window 1220 looks like, when the cells 1211, 1212, 1213 have been dragged there. Specifically, the cells labeled 1211 are being dragged 1230 to the form/window 1220 and they become text fields and check boxes 1221 when dropped, based on the type of the cells 1211. The type is predefined, but can be changed after the dragging takes place. Cells labeled 1212 have been dragged to the form/window 1220 to create items 1222, and a cell 1213 that contains a command has been dragged to the form/window 1220 to create a button 1223. This enables a programmer to directly manipulate the user interface of the window 1220 using the cells 1222, 1221, 1223 of the spreadsheet.

To accomplish the foregoing the present invention maps data types associated with cells of a spreadsheet 1210 to data types of form/window 1220. A translator then operates on the cell contents (object values) and copies or otherwise transfers (e.g. assembly) contents of cells 1211, 1212, 1213 from spreadsheet 1210 to corresponding items 1222, 1221, 1223 in form/window 1220. In some instances, the translator simply copies contents of cells 1211, 1212, 1213. In other instances, as a function of data type of items 1222, 1221, 1223 in form/window 1220, the translator processes and translates and generates objects using the cell contents from text, numerics, etc. of the spreadsheet 1220 to check boxes, button labels, data fields, etc. on a form/window 1220 as illustrated in FIGS. 12a-12b. Processing and translation may be rules-based, or through database exchange or by other programming techniques.

C. Overview Window.

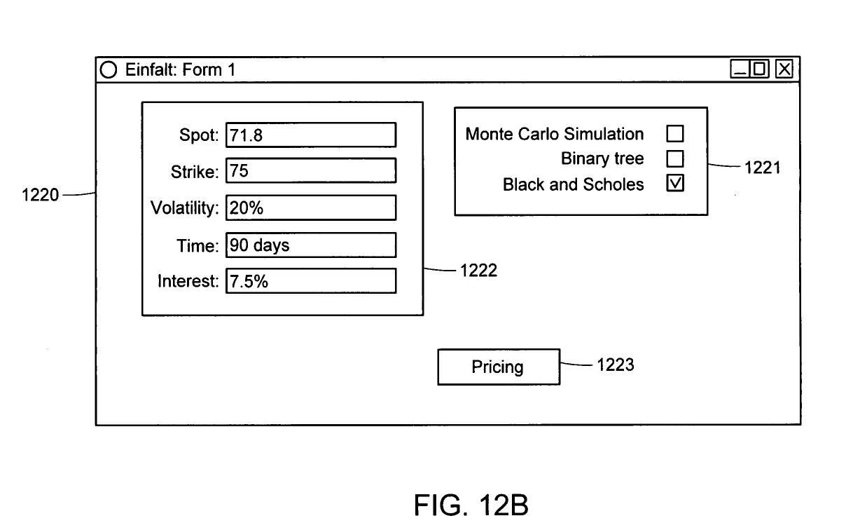

According to an embodiment of the invention, it is possible to open a screen view that provides an overview of the general structure of a program. See FIG. 13. In the overview screen 1301, icons of different types represent objects in the spreadsheet system. The picture shows a collection of icons 1302, that all represent objects. Two kinds of connections can be seen between objects in an overview window. Firstly, associations are shown that exist when an object uses an operation of another object, and are demonstrated by a simple line 1303 between the objects. Secondly, inheritance is shown as a line between objects with a triangle at the parent object (the one the child object inherits from) 1304. This way to draw associations and inheritance is traditional in object-oriented programming. A few operations are possible in the overview screen to help make programs easier to understand:
Shortcuts 1305 to objects can be created. This enables the corresponding icon representing a given shortcut to appear on more than one place on the screen. This is because the structure of objects can be complicated in some programming assignments and there can be many connections to one object. In this way, it is possible to make the picture simpler.
The size of the icons can be adjusted. Sometimes the user wants to see a larger picture and therefore make the icons smaller.
It is possible to group objects on the screen so that they will appear as one icon 1306, i.e. the objects are bundled together and are only represented by one icon. On FIG. 13 there are six connections to icon 1306, which represents three objects. The picture could be much more complicated if all three objects were shown. This is also, for instance, helpful when only one object within the package is connected with an object outside the group. Therefore, there is perhaps only one connection to the package. These objects can be seen as a whole on the picture and therefore it is easier to understand. To open a group and see what is inside, one can use graphical interface operations such as clicking with a mouse.
An icon can be set so that connections to it will not be displayed on the screen. This is to enable the user to clear the screen of any connections he does not want to see and will be of good use when many objects are connected to one object.
Icons can be chosen from a bar 1313, to create objects of different types in the overview window.
   D. Examples of Types of Objects

As shown in FIG. 13, in the overview screen, the discrete entities that make up various objects of a program can be viewed. The following are a few examples of the types of objects that can be used with the present invention.

An Electronic spreadsheets 1310 can represent objects in an object-oriented programming system. Such is the core of an embodiment of the invention. They have been discussed in more detail above.

A form or window 1320 is a type of input and output. With every form 1320 there is a spreadsheet object that allows calculations to be made quickly and easily. The sheet object can both make calculations on data that is entered into the form and data that is displayed on the form 1320.

A report 1330 is a type of output. Reports 1330 are made to enable the publishing of data for various uses, especially printing. With every report 1330 there is a corresponding spreadsheet. A report 1330 may be used like a word processor. There are links in a report to the data in the sheet accompanying it. Reports 1330 can, for example, be used to print contracts with different counterparties, dates and amounts.

Database connections 1340 are important in order to insert data into databases and make queries. A database connection 1340 is adjusted at the will of the user and connected with a sheet, where a useful association will be created, for example, the insertion of data into the database. With every database connection there may be a spreadsheet.

Printers 1350 are a kind of output. Objects of this kind will often be used to print reports. The properties such as the name of the printer 1350 can be set.

Input/output 1360 is an object that is used when other kinds of connections have to be made to hardware or the outside world. Those objects enable connection with e-mail, the world wide web, fax, telephone etc. When the button for input/output is pushed the user will get a list of the objects that can be chosen. The properties of those objects can be set and coding may not be necessary.

E. The Use of Colors.

According to an embodiment of the invention, colors may be used to indicate the type of each cell. For example, definitions of operations may have a colored frame. There may also be a colored frame surrounding the commands an operation uses. Another color may identify a cell that defines a function etc.

F. Syntax.

Although the syntax is shown herein in a certain way, it is possible that the syntax of coding will be essentially based on the syntax in some known programming language. Thus, the syntax or pseudocode herein is presented to illustrate concepts, not define implementation details.

G. Finding Errors.

One of the advantages of this embodiment over programming environments that do not utilize spreadsheets, is the fact that the code can in some ways be checked for errors at development time, i.e. as soon as code is entered. This is because of the ability of spreadsheet programs to show the result of a formula instantly in the cell in which it is placed.

H. Programming Language.

It is possible to implement the embodiments of the invention in different programming languages, e.g. Visual C++, Delphi, Java or other languages known in the art.

I. Object Management System.

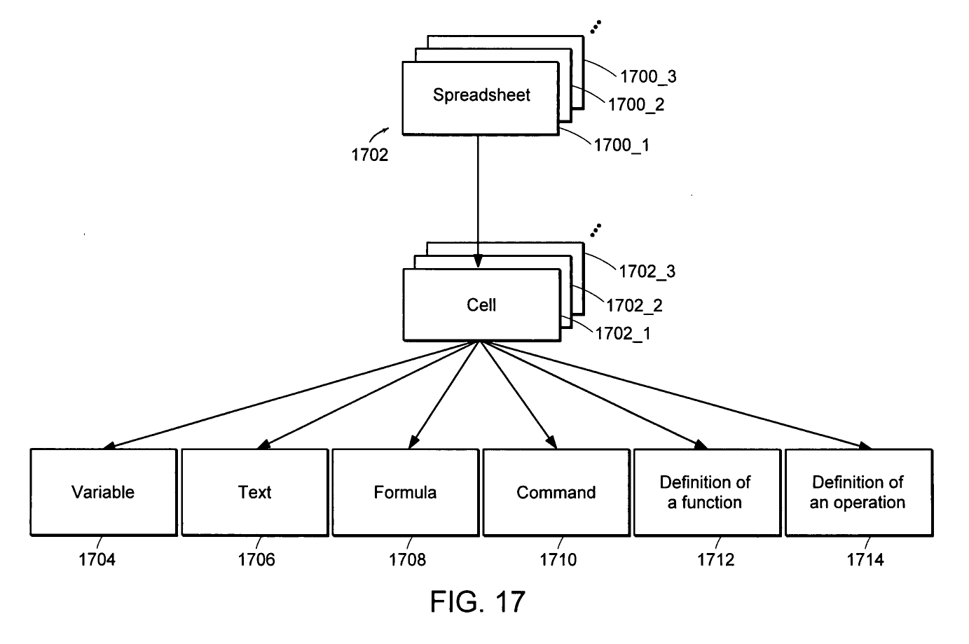

FIG. 17 is a block diagram illustrating the spreadsheet object-oriented programming system according to an embodiment of the invention. In this system, a software program 1700 can be developed and its collection of discrete objects 1700_1, 1700_2, 1700_3 can be managed with the spreadsheet program of the invention. Each object is a self-contained collection of data structures and routines, which interacts with other objects in the system. According to aspects of the invention, an object can be created by creating a spreadsheet 1700_1, 1700_2, 1700_3 with the invention. According to other aspects of the invention, an object can be created using the cells 1702_1, 1702_2, 1702_3 of a spreadsheet. In general, the object is an identifiable, encapsulated entity that provides one or more services that can be requested by other objects, components or systems that do not necessarily have to be apart of the software system 1700. Other objects or systems from within or outside of the system 1700 can invoke the appropriate operation (method) 1714 associated with the object, and the object carries out the operation using any input/output feature, e.g. (e.g. formulas 1708, commands 1710, functions 1712).

Aspects of the present system provide object management services that enable a programmer or automated system to create, locate and name objects. The complete set of object services to create objects provided by the present invention includes a suite of behaviors, functions and interface options (e.g. variables 1704, text 1706, formulas 1708, commands 1710, functions 1712, operations 1714) that can be incorporated into an object, which is represented by a spreadsheet. This suite of behaviors, functions and interface options provides object properties and services that can enable the creation, deletion, assignment and protection of properties, which are dynamic or static that are associated with the objects. The spreadsheet program of the invention, thus, provides object services to use, dynamically modify, and implement objects in developing a software program 1700.

The invention can enable object management services by providing a graphical means for identification and configuration management of objects as shown in the screen view in FIG. 13. This can also be used to manage object implementations and instances. Likewise, with the spreadsheet interface shown in FIG. 1, objects can also be managed in the same way.

Event creation and management capabilities are provided by the invention. The invention offers a variety of event types that can be associated with objects. The invention includes libraries for defining object behaviors. For example, a developer that is programming with the present system can create a button and can attach an event list to the object. The event list can always be associated with that object. The developer can also create events that are not built-in by defining them in a cell.

With the spreadsheet system of the invention, object life cycle services can be provided by using the inventive conventions for creating, deleting, copying and moving spreadsheets. Furthermore, naming services for objects can be provided with the invention. The invention can automatically bind a name to an object, and to locate an object by its name. For example, when a new object (spreadsheet) is created, the object by its name. For example, when a new object (spreadsheet) is created, the developer can select a name from a menu or specify a name while saving the spreadsheet. In addition, by selecting an object while it is displayed in the object overview window, a developer can specify its name.

While this invention has been particularly shown and described with references to preferred embodiments thereof, it will be understood by those skilled in the art that various changes in form and details may be made therein, without departing from the scope of the invention encompassed by the appended claims.

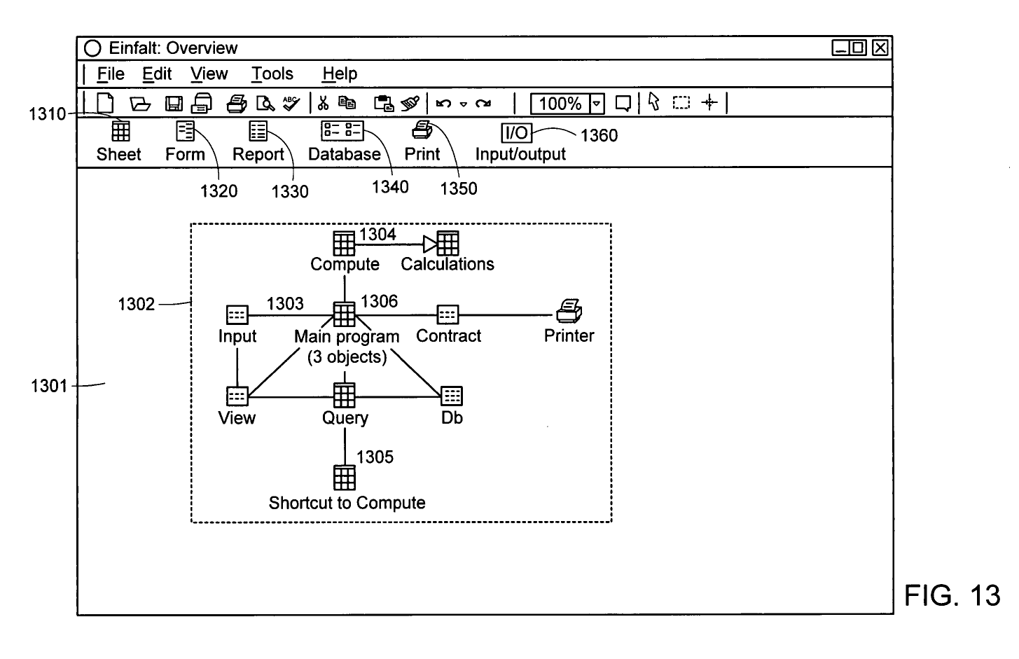

For example, it is understood that the forgoing embodiments of the present invention are carried out on a computer system 1000 shown in FIG. 14. The computer system 1000 generally includes a digital processor 1002, working memory 1004, I/O subsystems 1006 (input devices such as a mouse or keyboard, output devices such as a display monitor, etc.), and storage memory 1008. The software implementation of the invention is executed in working memory 1004 on a subject spreadsheet that may be subsequently stored in storage memory 1008. Other processing and storage handled through I/O subsystems 1006, processor 1002 and memories 1004, 1008 is in the purview of one skilled in the art. Computer system architecture may be client-server, distributed systems and other designs known in the art.

1. A method of developing computer software from an electronic spreadsheet, the method comprising the computer implemented steps of:
coupling content in at least one cell of an electronic spreadsheet to a window; and
determining properties of the window based on the content in the cell of the spreadsheet.

2. A method of developing computer software according to claim 1 wherein the step of coupling content in at least one cell of an electronic spreadsheet to a window further includes determining any graphical or functional attributes associated with the content in the cell to construct the window.

3. A method of developing computer software according to claim 1 wherein the content in the cell of the spreadsheet corresponds to the properties of the window in that any changes to the properties of the window are reflected in the content in the cell.

4. A method of developing computer software according to claim 1 wherein the step of coupling the content is in response to determining that an event has occurred.

5. A method of developing computer software according to claim 4 wherein the step of determining that an event has occurred includes determining that a drag and drop event type has occurred in that the content in the cell has been dragged from the cell to the window, and subsequently dropped onto the window.

6. A method of developing computer software according to claim 5 further includes the step of responding to the dropping of the content from the cell onto the window by:
(a) processing the content in the cell; and
(b) determining the properties of the window based on the content in the cell including determining any desired behavior or any desired appearance of the window based on the content in the cell.

7. A method of developing computer software according to claim 1 wherein the content in the cell includes any attributes associated with the cell.

8. A method of developing computer software according to claim 7 wherein the attributes include any input field, check box, radio button, menu object, popup menu object, label, button, combo box or list box.

9. A computer program product comprising:
a computer usable medium which includes computer readable program instructions for developing computer software with an electronic spreadsheet by:
(i) processing content associated with a cell of an electronic spreadsheet;
(ii) connecting the content in with the cell to a window; and
(iii) using the content associated with the cell, determining any attributes of the window.

10. A computer program product according to claim 9 wherein the instructions for connecting the content associated with the cell to a window further include instructions for assembling any graphical or functional attributes associated with the content in the cell to construct the window.

11. A computer program product according to claim 9 wherein the instructions for connecting the content associated with the cell to a window are in response to receiving an indication that an event has occurred.

12. A computer program product according to claim 11 wherein receiving an indication that an event has occurred includes determining that a drag and drop event type has occurred such that the content associated with the cell is dragged from the cell to the window, and subsequently dropped onto the window.

13. A computer program product according to claim 12 further includes instructions that respond to the dropping of the content onto the window by:
(a) processing the content associated with the cell; and
(b) determining the attributes of the window based on the content associated with the cell including determining any desired behavior or any desired appearance of the window.

14. A computer program product according to claim 9 wherein the content associated with the cell includes any data objects associated with the cell.

15. A computer program product according to claim 14 wherein the data objects associated with the cell include any input field, check box, radio button, menu object, popup menu object, label, button, combo box or list box.

16. An apparatus for developing computer software using an electronic spreadsheet, the apparatus comprising:
(a) an electronic spreadsheet having at least one input cell;
(b) instructions in the cell; and
(c) a window which reflects the instructions in the cell.

17. An apparatus according to claim 16 further including an assembly which:
processes the instructions in the cell; and
connects the instructions from the cell to the to the window.

18. An apparatus according to claim 17 wherein the assembly connects the instructions to the window in response to receiving an indication that an event has occurred.

19. An apparatus according to claim 18 wherein receiving an indication that an event has occurred includes determining that a drag and drop event type has occurred where the instructions in the cell are dragged from the cell to the window, and subsequently dropped onto the window to construct the window.

20. An apparatus according to claim 19 wherein the assembly responds to the dropping of the instructions onto the window by:
processing the instructions in the cell; and
determining the attributes of the window based on the instructions in the cell to define a behavior or appearance for the window.

21. An apparatus according to claim 16 wherein the instructions in the cell describe attributes associated with the cell.

22. An apparatus according to claim 21 wherein the attributes include any input field, check box, radio button, menu object, popup menu object, label, button, combo box or list box.

23. A system to develop computer software in a spreadsheet application, the system comprising:
a means for coupling instructions associated with at least one cell of an electronic spreadsheet to a window; and
a means for determining properties of the window based on any instructions associated with the cell of the spreadsheet.

24. An object-oriented computer programming method, the method comprising the computer implemented steps of:
representing an object in an object-oriented programming language with a respective spreadsheet, the spreadsheet having at least one cell storing instructions for the object; and
processing the object based on the instructions stored in the cell of the respective spreadsheet.

25. A method as claimed in claim 24 further comprises the step of identifying a hierarchy of parent and child objects, each object being represented by a respective spreadsheet, where the spreadsheet representing a parent object is a parent spreadsheet, the spreadsheet representing a child object of the parent object is a child spreadsheet, and the child spreadsheet inherits instructions from the parent spreadsheet.

26. A method as claimed in claim 24 wherein the instructions further include an operation which is processed when the object interacts with another object.

27. A method as claimed in claim 24 wherein the instructions further include any event, operation, message, function, command, formula, loop or variable.

28. A computer program product comprising:
a computer usable medium having computer readable program instructions for developing object-oriented computer software using an electronic spreadsheet by:
defining an object in an object-oriented programming language using a respective spreadsheet, the spreadsheet having at least one cell including content for the object; and
determining the behavior of the object based on the content included in the cell of the respective spreadsheet.

29. A computer program product as in claim 28 further include instructions for identifying a hierarchy of parent and child objects, each object being defined by a respective spreadsheet, such that the spreadsheet defining a parent object is a parent spreadsheet, the spreadsheet defining a child object of the parent object is a child spreadsheet, and the child spreadsheet inherits content associated with the parent spreadsheet.

30. A computer program product as in claim 28 further including instructions for sending a message to another object by processing an operation.

31. A computer program product as in claim 28 wherein the content in the cell includes at least one of: an event, operation, message, function, command, formula, loop and variable.

32. A spreadsheet apparatus for object-oriented programming comprising:
an electronic spreadsheet which represents an object defined in an object defined in an object-oriented programming language; and
at least one input cell in the spreadsheet having information about the object.

33. A spreadsheet apparatus for object-oriented programming as in claim 32 which further includes a hierarchy of parent and child objects, each object being represented by a respective spreadsheet, where the spreadsheet representing a parent object is a parent spreadsheet, the spreadsheet representing a child object of the parent object is a child spreadsheet, and the child spreadsheet inherits information from the parent spreadsheet.

34. A spreadsheet apparatus for object-oriented programming as in claim 32 wherein the information about the object includes at least one of: an event, operation, message, function, command, formula, loop and variable.

35. An object-oriented programming system with an electronic spreadsheet interface, the system comprising;
a means for representing an object in an object-oriented programming language with a respective spreadsheet, the spreadsheet having at least one cell storing instructions for the object; and
a means for processing the object based on the instructions stored in the cell of the respective spreadsheet.

36. A computerized method of developing object-oriented software from an electronic spreadsheet, the computerized method comprising:
defining a class in an object-oriented programming language by creating a respective spreadsheet.

37. A computerized method as described in claim 36 further includes creating an object associated with the class when the respective spreadsheet is created.

38. A computerized method as described in claim 36 wherein the respective spreadsheet includes cells that have information and operations for the class.

39. A computerized method as described in claim 36 further includes identifying a hierarchy of parent and child objects, each object being represented by a respective spreadsheet, in that the spreadsheet representing a parent object is a parent spreadsheet, the spreadsheet representing a child object of the parent object is a child spreadsheet, and the child spreadsheet inherits information from the parent spreadsheet.

40. A computerized method as described in claim 36 further comprising:
using an object-oriented programming operation defined in the respective spreadsheet, sending a message to an object.

41. A computerized method as described in claim 36 further includes determining a behavior of an object based on any information stored in the respective spreadsheet; and
wherein the information stored in the respective spreadsheet includes any: event, operation, message, function, command, formula, loop and variable.

42. A computer program product comprising:
a computer usable medium having computer readable code developing object-oriented software using an electronic spreadsheet by:
defining a class in an object-oriented programming language by creating a respective spreadsheet.

43. A computer program product as described in claim 42 further includes code that defines an object associated with the class when the respective spreadsheet is created.

44. A computer program product as described in claim 42 wherein the respective spreadsheet includes cells that have information and operations for the class.

45. A computer program product as described in claim 42 further includes code that identifies a hierarchy of parent and child objects, each object is represented by a respective spreadsheet, where the spreadsheet representing a parent object is a parent spreadsheet, the spreadsheet representing a child object of the parent object is a child spreadsheet, and the child spreadsheet inherits information from the parent spreadsheet.

46. A computer program product as described in claim 42 further comprising code that enables messaging between objects by processing an operation defined in the respective spreadsheet.

47. A computer program product as described in claim 42 further includes code for determining a behavior of an object based on information stored in the respective spreadsheet; and
wherein the information stored in the respective spreadsheet includes any: event, operation, message, function, command, formula, loop and variable.

48. An apparatus with an electronic spreadsheet interface for developing object-oriented software comprising:
a class defined in an object-oriented programming language in response to creating an electronic spreadsheet.

49. An apparatus as described in claim 48 further including an object associated with the class, the object being defined by the respective spreadsheet.

50. An apparatus as described in claim 48 wherein the respective spreadsheet includes cells that have information and operations for the class.

51. An apparatus as described in claim 48 further includes a hierarchy of parent and child objects, each object being defined by a respective spreadsheet, where the spreadsheet defining a parent object is a parent spreadsheet, the spreadsheet defining a child object of the parent object is a child spreadsheet, and the child spreadsheet inherits information from the parent spreadsheet.

52. An apparatus as described in claim 48 wherein the class defines an operation in an object-oriented programming language which is used to communicate between objects.

53. An apparatus as described in claim 48 further includes logic for determining a behavior of the object based on information stored in the spreadsheet; and
wherein the information stored in the spreadsheet includes an event, operation, message, function, command, formula, loop or variable.

54. An object-oriented programming system using an electronic spreadsheet, the system comprising:
a means for defining a class by creating a respective spreadsheet.

55. A method of providing text editor functionality in an electronic spreadsheet, the method comprising the computer implemented steps of:
defining a code column in an electronic spreadsheet; and
responding to a request for a newline by inserting a new cell in the code column.

56. A method according to claim 55 wherein the code column further includes text editor functionality in that the code column behaves as a text editor.

57. A method according to claim 56 wherein the request for a newline occurs when a keystroke input is received while a cell in the code column is selected.

58. A method according to claim 57 further includes:
inserting the new cell below the selected cell;
moving cells positioned below the selected cell to create space for the new cell; and
correcting any references to the cells which are moved.

59. A method according to claim 55 wherein the code column further includes scroll bars.

60. A method of computer programming according to claim 58 wherein the scroll bars enable scrolling through the code column independent of any scrolling of the spreadsheet.

61. A computer program product comprising:
a computer usable medium having computer readable program instructions which implement a computer programming environment in an electronic spreadsheet by:
creating a code column in an electronic spreadsheet; and
responding to a request for a newline by introducing a new cell in the code column.

62. A computer program product according to claim 61 wherein the code column provides text editor functionality.

63. A computer program product according to claim 62 wherein the request for a newline is determined in response to receiving a keystroke input while a cell in the code column is selected.

64. A computer program product according to claim 63 further includes instructions for:
inserting the new cell below the selected cell;
adjusting cells positioned below the selected cell to provide space for the new cell; and
in a cell that includes a reference to one of the adjusted cells, correcting the reference.

65. A computer program product according to claim 62 wherein the code column further includes scroll bars.

66. A computer program product according to claim 62 wherein the scroll bars enable scrolling through the code column independent of any scrolling of the spreadsheet.

67. An apparatus for developing computer software from an electronic spreadsheet comprising:
a code column in an electronic spreadsheet that responds to a request for a newline by introducing a new cell in the code column.

68. An apparatus according to claim 67 wherein the code column is a text editor in a column of the spreadsheet.

69. An apparatus according to claim 67 wherein the request for a newline occurs when a keystroke input is received while a cell in the code column is selected.

70. An apparatus according to claim 67 further includes logic for:
inserting the new cell below the selected cell;
adjusting the position of the cells below the selected cell to account for the new cell; and
updating a reference to one of the adjusted cells to reflect a new position for the adjusted cell.

71. An apparatus according to claim 67 wherein the code column in the spreadsheet includes scroll bars which enable scrolling through the code column independent of any scrolling of the spreadsheet.

72. A system for developing computer software in an electronic spreadsheet comprising:
a means for defining a code column in an electronic spreadsheet; and
a means for responding to a request for a newline by inserting a new cell in the code column.

73. A computerized method of object-oriented programming in an electronic spreadsheet system, the computerized method comprising:
in an electronic spreadsheet, creating an operation written in an object-oriented programming language; and
using the operation, interacting with another spreadsheet.

74. A method according to claim 73 further comprising:
in response to receiving a message from an object, processing the operation.

75. A method according to claim 73 wherein the spreadsheet is used to define an object written in an object-oriented programming language.

76. A method according to claim 75 further includes:
determining a behavior of the object based on any information stored in the spreadsheet; and
wherein the information stored in the respective spreadsheet includes any: event, operation, message, function, command, formula, loop and variable.

77. A method according to claim 73 further includes determining a hierarchy of parent and child objects, each object being represented by a respective spreadsheet, in that the spreadsheet representing a parent object is a parent spreadsheet, the spreadsheet representing a child object of the parent object is a child spreadsheet, and the child spreadsheet inherits information from the parent spreadsheet.

78. A computer program product comprising:
a computer readable medium having computer readable instructions that enable object-oriented computer software development using an electronic spreadsheet by:
creating an operation written in an object-oriented programming language with a spreadsheet, the operation being used to interact with one or more objects.

79. A computer program product according to claim 78 wherein the operation is processed when an object receives a message.

80. A computer program product according to claim 78 wherein the spreadsheet represents an object written in an object-oriented programming language.

81. A computer program product according to claim 80 further includes instructions that:
determine a behavior of the object based on any information stored in the spreadsheet; and
wherein the information stored in the respective spreadsheet includes any: event, operation, message, function, command, formula, loop and variable.

82. A computer program product according to claim 78 further include instructions that create a hierarchy of parent and child objects, each object being represented by a respective spreadsheet, where the spreadsheet representing a parent object is a parent spreadsheet, the spreadsheet representing a child object of the parent object is a child spreadsheet, and the child spreadsheet inherits information from the parent spreadsheet.

83. An apparatus for developing object-oriented computer software comprising:
an electronic spreadsheet which creates an operation written in an object-oriented programming language, the operation being used to interact with one or more objects.

84. An apparatus according to claim 83 wherein the operation is processed when an object receives a message.

85. An apparatus according to claim 83 further includes logic that:
determines a behavior of an object based on any information stored in the spreadsheet; and
wherein the information stored in the respective spreadsheet includes any: event, operation, message, function, command, formula, loop and variable.

86. An apparatus according to claim 83 further includes logic to identify a hierarchy of parent and child objects, each object being represented by a respective spreadsheet, such that the spreadsheet representing a parent object is a parent spreadsheet, the spreadsheet representing a child object of the parent object is a child spreadsheet, and the child spreadsheet inherits information from the parent spreadsheet.

87. A data processing system for developing computer software using an electronic spreadsheet, the system comprising:
a means for using a spreadsheet to create an operation written in an object-oriented programming language; and
a means for interacting with another spreadsheet by processing the operation.

88. A method of programming with an electronic spreadsheet, the method comprising the computer implemented steps of:
defining cells in a spreadsheet that are associated with an iterative process repeating for one or more cycles; and
at each cycle, determining whether to modify content in the cells associated with the iterative process.

89. A method of programming with an electronic spreadsheet as in claim 88 wherein at least one of the cells associated with the iterative process includes a final value cell, and at least one of the cells includes an initial value cell, where a value in the final value cell is used to modify a value in the initial value cell.

90. A method of programming with an electronic spreadsheet as in claim 88 wherein the iterative process is repeated for either a fixed number of times or until a condition defined in a condition cell no longer applies, or begins to apply.

91. A computer program product comprising:
a computer readable medium having computer program code which enables computer programming with an electronic spreadsheet by:
defining cells in a spreadsheet that are associated with an iterative process repeating for one or more cycles; and
at each cycle, determining whether to modify content in the cells associated with the iterative process.

92. A computer program product as in claim 91 wherein at least one of the cells associated with the iterative process includes a final value cell, and at least one of the cells includes an initial value cell, where a value in the final value cell is used to modify a value in the initial value cell.

93. A computer program product as in claim 91 wherein the iterative process is repeated for either a fixed number of times or until a condition defined in a condition cell no longer applies, or begins to apply.

94. An apparatus for programming using an electronic spreadsheet comprising:
a spreadsheet having cells that are associated with an iterative process repeating for one or more cycles; and
content in the spreadsheet being modifiable by the iterative process.

95. An apparatus as in claim 94 wherein the modifiable content further includes:
at least one of the cells associated with the iterative process is a final value cell;
at least one of the cells associated with the iterative process is an initial value cell; and
a value in the final value cell which influences a value in the initial value cell in each cycle of the iterative process.

96. An apparatus as in claim 94 wherein the iterative process is repeated for either a fixed number of times or until a condition defined in a condition cell no longer applies, or begins to apply.

97. A data processing system for programming using an electronic spreadsheet, the system comprising:
a means for defining cells in a spreadsheet that are associated with an iterative process that repeats for one or more cycles; and
at each cycle, a means for determining whether to modify content in the cells associated with the iterative process.
